(19) United States
(12) Patent Application Publication
(10) Pub. No.: US 2023/0367632 A1
(43) Pub. Date: Nov. 16, 2023

(54) JOB MANAGEMENT SYSTEM AND CONTROL METHOD THEREOF

(71) Applicant: RAKUTEN MOBILE, INC., Tokyo (JP)

(72) Inventor: Kazushige TAKEUCHI, Tokyo (JP)

(21) Appl. No.: 18/044,786

(22) PCT Filed: Sep. 1, 2021
(86) PCT No.: PCT/JP2021/032201

§ 371 Date: Mar. 10, 2023

(51) Int. Cl. G06F 9/48

(52) U.S. Cl. CPC G06F 9/4881

(57) ABSTRACT

Provided are a job management system and a control method thereof which enable seamless switching of job execution modules to be accomplished. When a job uncompleted by a first job execution module (14a) exists, a switching module (30) switches a destination to which an execution request output module (24) outputs an execution request to execute a job, from a first execution control module (32a) to a second execution control module (32b). A first inquiry module (36a) issues, to the first job execution module (14a), an inquiry about a status of a job for which execution has been instructed to the first job execution module (14a). When execution of a job uncompleted by the first job execution module (14a) is determined to be a failure based on a result of the inquiry after the destination to which an execution request to execute a job is output is switched to the second execution control module (32b), the execution request output module (24) outputs an execution request to execute the job to the second execution control module (32b).

### TECHNICAL FIELD

The present invention relates to a job management system and a control method thereof.

### BACKGROUND ART

As an example of a technology relating to construction of a functional unit group in accordance with purchase of a network service, in Patent Literature 1, there is described a technology for deconstructing an order of a product purchased by a customer into virtualized network function (VNF) units and deploying the VNF units on a network functions virtualization infrastructure (NFVI).

There has also been known a technology for causing a job execution module such as a workflow engine to execute the deployment of the VNF described above and other jobs.

### CITATION LIST

### Patent Literature

[Patent Literature 1] WO 2018/181826 A1

### SUMMARY OF INVENTION

### Technical Problem

A job execution module that is in operation may be switched to a different type of job execution module due to, for example, replacement. There is also a case in which a job execution module that is in operation is switched to another job execution module having the same function due to version upgrade or the like.

In such cases of switching of job execution modules, execution of a job is required to be ceased until the switching of job execution modules is finished, even with the use of the technology as described in Patent Literature 1.

The present invention has been made in view of the above-mentioned circumstance, and has an object to provide a job management system and a control method thereof which enable seamless switching of job execution modules to be accomplished.

### Solution to Problem

In order to solve the above-mentioned problem, according to one embodiment of the present invention, there is provided a job management system including: first execution control means for instructing, in response to reception of an execution request to execute a job, a first job execution module to execute the job; second execution control means for instructing, in response to reception of an execution request to execute a job, a second job execution module to execute the job; execution request output means for outputting one execution request to execute a job at a time to the first execution control means; a switching means for switching, when a job uncompleted by the first job execution module exists, a destination to which the execution request output means outputs an execution request to execute a job, from the first execution control means to the second execution control means; and first inquiry means for issuing, to the first job execution module, an inquiry about a status of a job for which execution has been instructed to the first job execution module, wherein, when execution of a job uncompleted by the first job execution module is determined to be a failure based on a result of the inquiry after the destination to which an execution request to execute a job is output is switched to the second execution control means, the execution request output means is configured to output an execution request to execute the job to the second execution control means.

In one aspect of the present invention, the first inquiry means is configured to end the issuing of an inquiry in response to completion of determination, based on a result of the inquiry, on success or failure of execution for every job for which execution has been instructed to the first job execution module.

Otherwise, the first inquiry means is configured to end the issuing of an inquiry in response to confirmation, based on a result of the inquiry, that execution has ended for every job for which execution has been instructed to the first job execution module.

Further, in one aspect of the present invention, the job management system further includes: execution request reception means for receiving an execution request to execute a job from an operation support system; and job data storage means for storing job data indicating the job, the execution request output means is configured to acquire one piece of the job data stored in the job data storage means at a time, the execution request output means is configured to output, in response to acquisition of a piece of the job data from the job data storage means, an execution request to execute a job indicated by the piece of the job data to the first execution control means, before the destination to which an execution request to execute a job is output is switched to the second execution control means, and the execution request output means is configured to output, in response to acquisition of a piece of the job data from the job data storage means, an execution request to execute a job indicated by the piece of the job data to the second execution control means, after the destination to which an execution request to execute a job is output is switched to the second execution control means.

In this aspect, the job management system may further include notification means for notifying, to the operation support system, success, or failure of execution of a job that is determined based on a result of the inquiry.

Further, the job management system may further include second inquiry means for issuing, to the second job execution module, an inquiry about a status of a job for which execution has been instructed to the second job execution module, and the notification means may be configured to notify, to the operation support system, during a period in which the first inquiry means and the second inquiry means each issue an inquiry, success or failure of execution of a job that is determined based on a result of an inquiry issued by the first inquiry means and success or failure of execution of a job that is determined based on a result of an inquiry issued by the second inquiry means.

Further, when execution of a job uncompleted by the first job execution module is determined to be a failure based on a result of the inquiry after the destination to which an execution request to execute a job is output is switched to the second execution control means, the execution request output means may be configured to output an execution request to execute the job to the second execution control means, without the notification means notifying the failure of the execution of the job to the operation support system.

Further, according to one embodiment of the present invention, there is provided a control method for a job management system, the job management system including: first execution control means for instructing, in response to reception of an execution request to execute a job, a first job execution module to execute the job; and second execution control means for instructing, in response to reception of an execution request to execute a job, a second job execution module to execute the job, the control method including the steps of: outputting one execution request to execute a job at a time to the first execution control means; switching, when a job uncompleted by the first job execution module exists, a destination to which an execution request to execute a job is output, from the first execution control means to the second execution control means; issuing, to the first job execution module, an inquiry about a status of a job for which execution has been instructed to the first job execution module; and outputting, when execution of a job uncompleted by the first job execution module is determined to be a failure based on a result of the inquiry after the destination to which an execution request to execute a job is output is switched to the second execution control means, an execution request to execute the job to the second execution control means.

### BRIEF DESCRIPTION OF DRAWINGS

FIG. 1 is a diagram for illustrating an example of a job control system.

FIG. 2 is a diagram for illustrating an example of a configuration of a job management system.

FIG. 3 is a table for showing an example of job status data.

FIG. 4 is a diagram for illustrating an example of the job control system.

FIG. 5 is a table for showing an example of the job status data.

FIG. 6 is a diagram for illustrating an example of the job control system.

FIG. 7 is a flow chart for illustrating an example of a flow of a process executed in the job management system.

FIG. 8 is a flow chart for illustrating an example of a flow of a process executed in the job management system.

### DESCRIPTION OF EMBODIMENTS

One embodiment of the present invention is now described in detail with reference to the drawings.

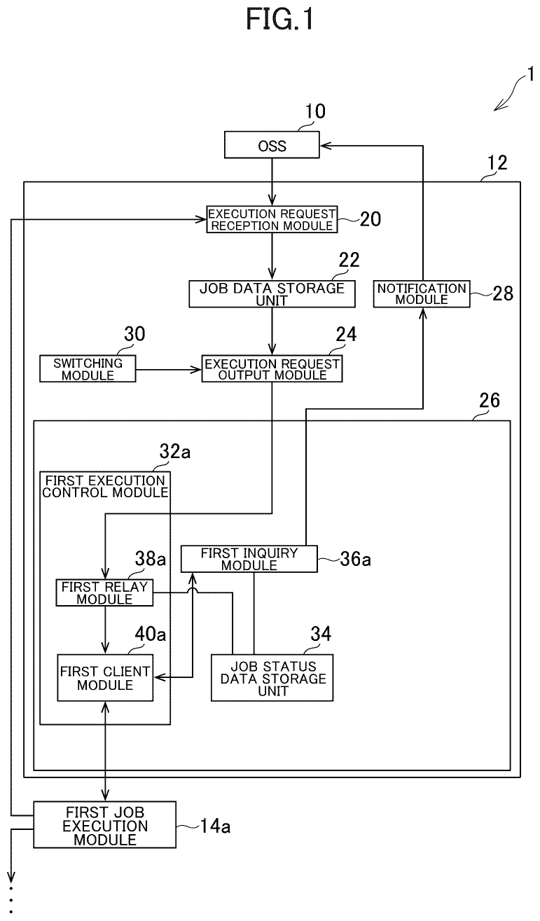

FIG. 1 is a diagram for illustrating an example of a job control system 1 in the one embodiment of the present invention. As illustrated in FIG. 1, the job control system 1 in this embodiment includes an operation support system (OSS) 10, a job management system 12, and job execution modules 14. In FIG. 1, a first job execution module 14a is illustrated as an example of the job execution modules 14 included in the job control system 1.

As illustrated in FIG. 1, the job management system 12 includes an execution request reception module 20, a job data storage unit 22, an execution request output module 24, an abstraction layer 26, a notification module 28, and a switching module 30. The abstraction layer 26 includes one of execution control modules 32, a job status data storage unit 34, and one of inquiry modules 36. The one of the execution control modules 32 includes one of relay modules 38 and one of client modules 40. In FIG. 1, a first execution control module 32a is illustrated as an example of the execution control modules 32 included in the job control system 1. A first inquiry module 36a is illustrated as an example of the inquiry modules 36. A first relay module 38a is illustrated as an example of the relay modules 38. A first client module 40a is illustrated as an example of the client modules 40.

The OSS 10 and the job management system 12 according to this embodiment are each a cloud platform on which a cluster of nodes (can be said to be computers or servers) that execute containerized applications is constructed, or a similar computer system.

The job management system 12 and the job execution modules 14 in this embodiment may be clusters constructed in a central data center (CDC) that is a data center of, for example, a mobile communications carrier.

Clusters in this embodiment are each, for example, a set of nodes in which software used to manage containerized workloads or services (a specific example of the software is Kubernetes) is installed. Another example of the clusters in this embodiment is a Kubernetes cluster defining a range in which Kubernetes can manage a pod, which is a containerized application. A Kubernetes cluster can be said to be a set of nodes across which Kubernetes can deploy a pod.

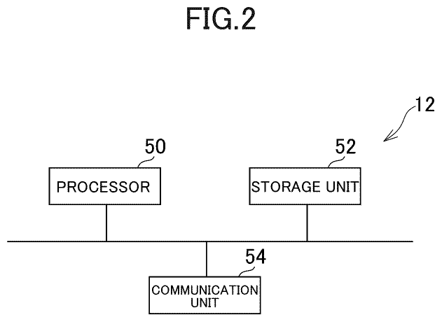

FIG. 2 is a diagram for illustrating an example of a configuration of the job management system 12 according to this embodiment. As illustrated in FIG. 2, the job management system 12 according to this embodiment includes, for example, a processor 50, a storage unit 52, and a communication unit 54. The processor 50 is a program control device, for example, a microprocessor operating in accordance with a program installed in the job management system 12. The storage unit 52 is, for example, a ROM, a RAM, or a similar storage element, a solid state drive (SSD), or a hard disk drive (HDD). The storage unit 52 stores, among others, a program executed by the processor 50. The communication unit 54 is a communication interface, for example, a network interface card (NIC) or a wireless LAN module. Software-defined networking (SDN) may be implemented in the communication unit 54. The communication unit 54 exchanges data with the OSS 10, a cluster constructed in an external data center (a regional data center (RDC), an edge data center, or the like), and others.

The execution request reception module 20 is implemented mainly by the processor 50 and the communication unit 54. The job data storage unit 22 and the job status data storage unit 34 are implemented mainly by the storage unit 52. The execution request output module 24, the execution control modules 32, the inquiry modules 36, and the switching module 30 are implemented mainly by the processor 50, the storage unit 52, and the communication unit 54. The notification module 28 is implemented mainly by the communication unit 54.

Those functions may be implemented by execution of a program being installed in the job management system 12, which is a computer, and including commands that correspond to those functions by the processor 50. This program may be supplied to the job management system 12 via a computer-readable information storage medium, for example, an optical disc, a magnetic disk, a magnetic tape, a magneto-optical disc, or a flash memory, or via the Internet or the like.

The OSS 10 in this embodiment transmits, for example, an execution request to execute a job to the job management system 12. The execution request reception module 20 of the job management system 12 receives this execution request from the OSS 10. A job of constructing a network service (NS) can be given as an example of the job. The execution request to execute a job may be transmitted to the job management system 12 in accordance with an instruction from an administrator or a user of the OSS 10.

The execution request reception module 20 in this embodiment then generates, for example, job data indicating a job that is to be executed and corresponds to the received execution request, and outputs the job data to the job data storage unit 22.

In this embodiment, the job data storage unit 22 stores, for example, job data indicating a job to be executed. For instance, the job data storage unit 22 receives and stores job data output from the execution request reception module 20.

The job data in this embodiment may be, for example, data indicating a job of constructing an element to be included in a fourth generation mobile communication system (4G) or a fifth generation mobile communication system (5G). To give a more specific example, the job data may be data indicating a job of constructing an NS, a network function (NF), a containerized network function component (CNFC), a pod, or another element to be included in a 4G or 5G communication system. The job data may include location data indicating a location at which the element is to be constructed.

In this embodiment, the execution request output module 24 acquires, for example, one piece of job data stored in the job data storage unit 22 at a time. When a piece of job data is acquired from the job data storage unit 22, the execution request output module 24 deletes the piece of job data from the job data storage unit 22.

In this embodiment, the execution request output module 24 then outputs, for example, one execution request to execute a job at a time to one of the execution control modules 32. In the example of FIG. 1, the execution request output module 24 outputs one execution request to execute a job at a time to the first execution control module 32a. In this embodiment, the execution request output module 24 outputs, for example, an execution request to execute a job corresponding to a piece of job data acquired from the job data storage unit 22 to the one of the execution control modules 32. In this embodiment, when a plurality of pieces of job data are stored in the job data storage unit 22, for example, the execution request output module 24 outputs, for the plurality of pieces of job data, execution requests to execute jobs corresponding to the plurality of pieces of job data to the one of the execution control modules 32, in order.

Then, in this embodiment, for example, the one of the execution control modules 32 instructs, in response to reception of the execution request to execute the job, one of the job execution modules 14 to execute the job. In the example of FIG. 1, the first execution control module 32a instructs the first job execution module 14a to execute the job in response to reception of the execution request to execute the job.

In this embodiment, for example, the execution request output module 24 outputs the execution request to execute the job to the first relay module 38a included in the first execution control module 32a. The first relay module 38a outputs this execution request to the first client module 40a. The first client module 40a outputs an instruction to execute the job requested by this execution request to the first job execution module 14a.

In this embodiment, the one of the job execution modules 14 receives, for example, the instruction to execute the job from the one of the execution control modules 32, and executes the job. The job execution modules 14 may each be implemented so as to include a workflow engine or a similar job execution engine.

In this embodiment, the one of the job execution modules 14 may generate at least one new execution request to execute a job, in response to reception of an instruction to execute a job. For example, in response to reception of a request to construct an NS, a request to construct a plurality of NFs to be included in the NS may be generated. In response to reception of a request to construct an NF, a request to construct a plurality of containerized network function components (CNFCs) to be included in the NF may be generated. In response to reception of a request to construct a CNFC, a request to construct a plurality of pods to be included in the CNFC may be generated.

The one of the job execution modules 14 may output the at least one newly generated execution request to execute a job to the execution request reception module 20.

For example, in response to reception of a request to construct a pod, the one of the job execution modules 14 may construct the pod. The one of the job execution modules 14 may output, for example, a request to deploy the pod to Kubernetes installed in the job management system 12, or Kubernetes installed in a cluster in an external data center. Kubernetes that receives the request to deploy the pod may deploy the pod.

In the example of FIG. 1, the first job execution module 14a receives the instruction to execute the job from the first client module 40a of the first execution control module 32a, and executes the job.

In this embodiment, the job status data storage unit 34 stores, for example, job status data indicating a status of a job instructed to be executed by the one of the job execution modules 14.

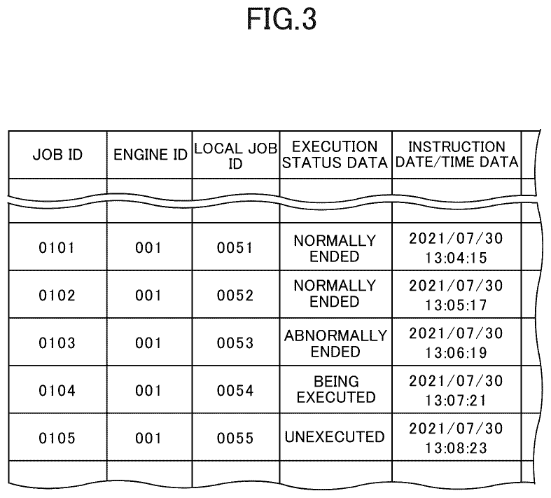

FIG. 3 is a table for showing an example of the job status data. As shown in FIG. 3, the job status data in this embodiment includes, for example, a job ID, an engine ID, a local job ID, execution status data, instruction date/time data, and the like.

The job status data is data associated with a job for which execution has been instructed to one of the job execution modules 14 in response to an execution request received by the job management system 12 from the OSS 10.

In this embodiment, the job ID is, for example, job identification information uniquely assigned to a job for which an execution request has been received from the OSS 10. For example, identification information of a job linked to an execution request received from the OSS 10 may be set as the job ID of the job status data that is associated with the job.

In this embodiment, the engine ID is, for example, identification information of the one of the job execution modules 14 to which an instruction to execute the job is issued. In the example of FIG. 1, the job management system 12 issues an instruction to execute a job only to the first job execution module 14a. Accordingly, in the example of FIG. 3, “001”, which is a value associated with the first job execution module 14a, is set as the engine ID in every piece of job status data.

In this embodiment, the local job ID is, for example, identification information locally managed by the one of the job execution modules 14 as identification information of a job for which an execution instruction has been received by the one of the job execution modules 14. The same value as the job ID may be set as a value of the local job ID.

In this embodiment, the execution status data is, for example, data indicating an execution status of a job for which execution has been instructed to the one of the job execution modules 14. In FIG. 3, “normally ended” indicating that execution has ended normally, “abnormally ended” indicating that execution has ended abnormally, “being executed” indicating that execution of the job is in progress, and “unexecuted” indicating that the job is yet to be executed are shown as an example of values of the execution status data. Values of the execution status data are not limited to those given as an example. As described later, the value of the execution status data is properly updated based on a result of an inquiry by the one of the inquiry modules 36.

In this embodiment, the instruction date/time data is, for example, data indicating a date/time of instruction to execute the job.

In this embodiment, for example, the one of the execution control modules 32 may generate a piece of job status data associated with a job at the same time as outputting an instruction to execute the job to the one of the job execution modules 14. The one of the execution control modules 32 may store the generated piece of job status data in the job status data storage unit 34.

In the example of FIG. 1, when the first execution control module 32a outputs an instruction to execute a job to the first job execution module 14a, a piece of job status data associated with the job may be generated at that time. The first execution control module 32a may store the generated piece of job status data in the job status data storage unit 34.

For example, the first relay module 38a may generate a piece of job status data associated with a job at the same time as outputting an execution request to execute the job to the first client module 40a, and store the generated piece of job status data in the job status data storage unit 34. In this case, a date/time at which the execution request to execute the job is output to the first client module 40a may be set to the instruction date/time data included in the piece of job status data.

The first client module 40a may generate a piece of job status data associated with a job at the same time as outputting an instruction to execute the job to the first job execution module 14a, and store the generated piece of job status data in the job status data storage unit 34. In this case, a date/time at which the instruction to execute the job is output to the first job execution module 14a may be set to the instruction date/time data included in the piece of job status data.

In this embodiment, the one of the inquiry modules 36 issues, for example, an inquiry about a status of a job for which execution has been instructed to the one of the job execution modules 14, with the inquiry addressed to the one of the job execution modules 14. The one of the inquiry modules 36 may execute the issuing of the inquiry to the one of the job execution modules 14 at, for example, predetermined time intervals.

As illustrated in FIG. 1, the one of the inquiry modules 36 may issue an inquiry about a status of a job for which execution has been instructed to one of the job execution modules 14, via one of the client modules 40. For example, the one of the inquiry modules 36 may transmit a job ID of the job for which the inquiry about the status is issued, to the one of the client modules 40. The one of the client modules 40 may access the one of the job execution modules 14 to identify a status of a job associated with the job ID. The one of the client modules 40 may then transmit data indicating the identified status of the job to the one of the inquiry modules 36.

Each one of the inquiry modules 36 in this embodiment is associated with one of the job execution modules 14. The one of the inquiry modules 36 identifies a piece of job status data including an engine ID associated with the one of the job execution modules 14 that is associated with the one of the inquiry modules 36. The one of the inquiry modules 36 then issues an inquiry about a job status indicated by the identified piece of job status data to the one of the job execution modules 14 that is associated with the one of the inquiry modules 36.

For example, the one of the inquiry modules 36 may issue an inquiry about a job status associated with a piece of job status data that includes the execution status data indicating that the job has not been completed, to the one of the job execution modules 14 that is associated with the one of the inquiry modules 36. In the example of FIG. 3, the execution status data indicating that the job has not been completed is, for example, the execution status data having the value “unexecuted” or “being executed.”

In the example of FIG. 1, it is assumed that the first inquiry module 36a is associated with, for example, the first job execution module 14a. In this case, the first inquiry module 36a may issue an inquiry about a status of a job for which execution has been instructed to the first job execution module 14a, with the inquiry addressed to the first job execution module 14a. For example, the first inquiry module 36a may issue, to the first job execution module 14a, an inquiry about a job status associated with a piece of job status data that has “001” as the value of the engine ID, out of pieces of job status data stored in the job status data storage unit 34.

The one of the inquiry modules 36 may then update the execution status data included in the piece of job status data for which the inquiry has been issued, based on a result of the inquiry described above.

For example, the one of the inquiry modules 36 may update, in response to confirmation of a fact that a job has changed from “unexecuted” to “being executed,” the value of the execution status data included in the job status data of this job to “being executed.”

The one of the inquiry modules 36 may update, in response to confirmation of a fact that a job being executed has ended normally, the value of the execution status data included in the job status data of this job to “normally ended.”

The one of the inquiry modules 36 may update, in response to confirmation of a fact that a job being executed has ended abnormally, the value of the execution status data included in the job status data of this job to “abnormally ended.”

For a job confirmed to have ended normally, the one of the inquiry modules 36 outputs a normal completion notification linked to the job ID of the job to the notification module 28. For a job confirmed to have ended abnormally, the one of the inquiry modules 36 outputs an abnormal completion notification linked to the job ID of the job to the notification module 28.

For a job that has timed out, the one of the inquiry modules 36 may output an abnormal completion notification linked to the job ID of the job to the notification module 28. For example, the one of the inquiry modules 36 may output, to the notification module 28, an abnormal completion notification linked to the job ID of a job that has not ended normally or abnormally after elapse of a predetermined time since a date/time indicated by the instruction date/time data. In this case, the one of the inquiry modules 36 may update the value of the execution status data included in the job status data of this job to “abnormally ended.”

In this embodiment, the first inquiry module 36a updates the execution status data included in the job status data of a job about which an inquiry has been issued to the first job execution module 14a, based on a result of the inquiry, in the manner described above.

For a job confirmed to have ended normally based on a result of the inquiry to the first job execution module 14a, the first inquiry module 36a outputs a normal completion notification linked to the job ID of the job to the notification module 28. For a job confirmed to have ended abnormally based on a result of the inquiry to the first job execution module 14a, the first inquiry module 36a outputs an abnormal completion notification linked to the job ID of the job to the notification module 28.

For a job for which execution has been instructed to the first job execution module 14a and which has timed out, the first inquiry module 36a may output an abnormal completion notification linked to the job ID of the job to the notification module 28.

In this embodiment, the notification module 28 notifies, for example, success or failure of job execution that is determined based on a result of an inquiry issued by the one of the inquiry modules 36 to the OSS 10. The notification module 28 may transmit, in response to reception of a normal completion notification from the one of the inquiry modules 36, the normal completion notification to the OSS 10. The notification module 28 may transmit, in response to reception of an abnormal completion notification from the one of the inquiry modules 36, the abnormal completion notification to the OSS 10.

The OSS 10 may transmit, in response to reception of an abnormal completion notification, a retry request to retry the job that has ended abnormally to the job management system 12.

When a predetermined time-out period elapses since transmission of an execution request to execute a job to the job management system 12, and the job is still not confirmed to have ended, the OSS 10 may transmit an execution request that is a request to retry the job to the job management system 12. For example, when a predetermined time-out period elapses since transmission of an execution request to execute a job to the job management system 12 without receiving any of the normal completion notification and the abnormal completion notification described above for the job, an execution request that is a request to retry the job may be transmitted.

In this embodiment, the switching module 30 switches, for example, a destination to which the execution request output module 24 outputs an execution request to execute a job. The switching module 30 may switch the destination to which the execution request output module 24 outputs an execution request to execute a job in response to reception of a switch instruction signal from a terminal used by an administrator of the job management system 12.

When the job control system 1 illustrated in FIG. 1 is in operation, the first job execution module 14a which is running may be switched to another of the job execution modules 14 that has a different type, due to replacement or the like. The first job execution module 14a which is running may also be switched to another of the job execution modules 14 that has the same function, due to version upgrade or the like.

Description is given below of an example of a switching process related to the cases of switching described above and other cases of switching of the job execution modules 14 in this embodiment.

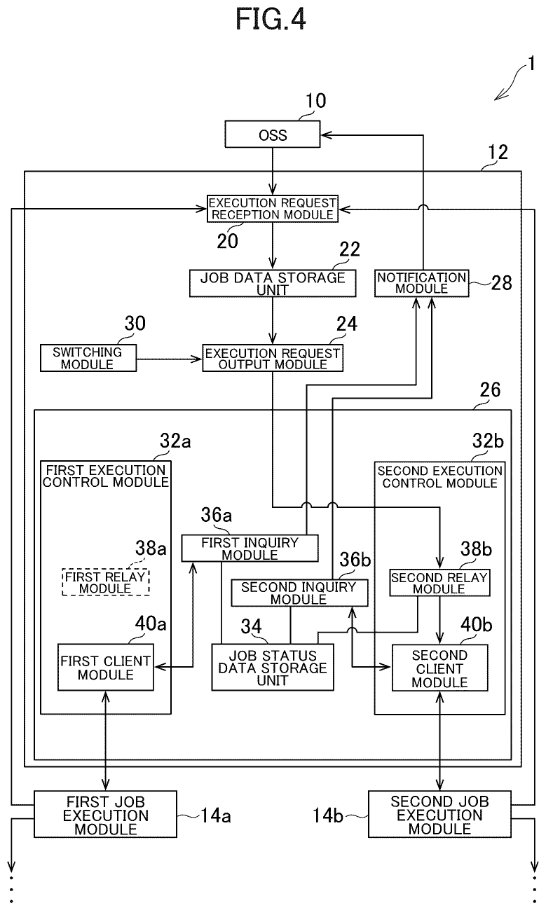

FIG. 4 is a diagram for illustrating an example of the job control system 1 after a shift from one job execution engine to another. As illustrated in FIG. 4, in the job control system 1, a second job execution module 14b is illustrated as one of the job execution modules 14 that is to be used after the switching.

The second job execution module 14b may be, for example, one of the job execution modules 14 of a type (vendor) different from the first job execution module 14a. The second job execution module 14b may also be one of the job execution modules 14 that has the same type as the first job execution module 14a and is an upgraded version of the first job execution module 14a.

In the switching process, as illustrated in FIG. 4, a second execution control module 32b and a second inquiry module 36b are newly activated first in the job management system 12. The second execution control module 32b includes, as illustrated in FIG. 4, a second relay module 38b and a second client module 40b.

The switching module 30 then switches the destination to which the execution request output module 24 outputs an execution request to execute a job from the first execution control module 32a to the second execution control module 32b. In this embodiment, when there is a job that has not been completed by the first job execution module 14a, the switching module 30 switches the destination to which the execution request output module 24 outputs an execution request to execute a job from the first execution control module 32a to the second execution control module 32b. That is, the destination to which an execution request to execute a job is output is switched when a piece of job status data that has “001” as the value of the engine ID and “unexecuted” or “being executed” as the value of the execution status data is found among pieces of job status data stored in the job status data storage unit 34.

The first relay module 38a included in the first execution control module 32a is then stopped as illustrated in FIG. 4, and the switching process is ended.

In this embodiment, the job management system 12 may execute the switching process described above in response to the reception of the switch instruction signal from the terminal used by the administrator of the job management system 12.

As described above, before the destination to which the execution request output module 24 outputs an execution request to execute a job is switched to the second execution control module 32b, the execution request output module 24 outputs, in response to acquisition of job data from the job data storage unit 22, an execution request to execute a job indicated by the job data to the first execution control module 32a.

After the destination to which the execution request output module 24 outputs an execution request to execute a job is switched to the second execution control module 32b, the execution request output module 24 outputs, in response to acquisition of job data from the job data storage unit 22, an execution request to execute a job indicated by the job data to the second execution control module 32b. The second execution control module 32b instructs, in response to reception of the execution request to execute the job, the second job execution module 14b to execute the job.

For example, after the destination to which an execution request to execute a job is switched to the second execution control module 32b, the execution request output module 24 outputs an execution request to execute a job to the second relay module 38b included in the second execution control module 32b. The second relay module 38b outputs this execution request to the second client module 40b. The second client module 40b outputs an instruction to execute the job requested by this execution request to the second job execution module 14b.

The second job execution module 14b receives the instruction to execute the job from the second client module 40b of the second execution control module 32b, and executes the job.

As described above, similarly to the first job execution module 14a, the second job execution module 14b may generate at least one new execution request to execute a job, in response to reception of an instruction to execute a job. The second job execution module 14b may output the at least one newly generated execution request to execute a job to the execution request reception module 20.

Similarly to the first job execution module 14a, the second job execution module 14b may construct a pod in response to reception of a request to construct the pod. For example, the second job execution module 14b may output a request to deploy the pod to Kubernetes installed in the job management system 12, or Kubernetes installed in a cluster in an external data center. Kubernetes that receives the request to deploy the pod may deploy the pod.

In the example of FIG. 4, the second execution control module 32b may generate a piece of job status data linked to a job at the same time as outputting an instruction to execute the job to the second job execution module 14b. The second execution control module 32b may then store the generated piece of job status data in the job status data storage unit 34. In the following description, “002”, which is a value associated with the second job execution module 14b, is set to the engine ID of a piece of job status data to be stored in the job status data storage unit 34 in this manner.

For example, the second relay module 38b may generate a piece of job status data associated with a job at the same time as outputting an execution request to execute the job to the second client module 40b, and store the generated piece of job status data in the job status data storage unit 34. In this case, a date/time at which the execution request to execute the job is output to the second client module 40b may be set to the instruction date/time data included in the piece of job status data.

The second client module 40b may generate a piece of job status data associated with a job at the same time as outputting an instruction to execute the job to the second job execution module 14b, and store the generated piece of job status data in the job status data storage unit 34. In this case, a date/time at which the instruction to execute the job is output to the second job execution module 14b may be set to the instruction date/time data included in the piece of job status data.

In this embodiment, a form (for example, data structure or format) of an execution request that is receivable by the first relay module 38a may be the same as a form of an execution request that is receivable by the second relay module 38b. A form of an execution request output by the execution request output module 24 to the first relay module 38a may be the same as a form of an execution request output by the execution request output module 24 to the second relay module 38b.

The form of an execution request output by the execution request output module 24 to the first relay module 38a and the form of an execution request output by the execution request output module 24 to the second relay module 38b may be different from each other.

In this embodiment, a form of an execution request that is receivable by the first client module 40a may be the same as a form of an execution request that is receivable by the second client module 40b. A form of an execution request output by the first relay module 38a to the first client module 40a may be the same as a form of an execution request output by the second relay module 38b to the second client module 40b.

In this embodiment, the first client module 40a is, for example, a client module associated with the first job execution module 14a, and outputs an execution instruction having a form receivable by the first job execution module 14a to the first job execution module 14a.

In this embodiment, the second client module 40b is, for example, a client module associated with the second job execution module 14b, and outputs an execution instruction having a form receivable by the second job execution module 14b to the second job execution module 14b.

The second inquiry module 36b in this embodiment is associated with the second job execution module 14b. In this case, an inquiry about a status of a job for which execution has been instructed to the second job execution module 14b may be issued to the second job execution module 14b. For example, the second inquiry module 36b may issue, to the second job execution module 14b, an inquiry about a status of a job associated with a piece of job status data that has “002” as the value of the engine ID, out of pieces of job status data stored in the job status data storage unit 34.

The second inquiry module 36b then updates the execution status data included in the job status data of the job about which the inquiry has been issued, based on a result of the inquiry to the second job execution module 14b, in the manner described above.

For a job confirmed to have ended normally based on a result of the inquiry to the second job execution module 14b, the second inquiry module 36b outputs a normal completion notification linked to the job ID of the job to the notification module 28. For a job confirmed to have ended abnormally based on a result of the inquiry to the second job execution module 14b, the second inquiry module 36b outputs an abnormal completion notification linked to the job ID of the job to the notification module 28.

For a job for which execution has been instructed to the second job execution module 14b and which has timed out, the second inquiry module 36b may output an abnormal completion notification linked to the job ID of the job to the notification module 28.

In this embodiment, the notification module 28 notifies, during a period in which an inquiry is issued by the first inquiry module 36a, success or failure of job execution that is determined based on a result of the inquiry issued by the first inquiry module 36a to the OSS 10 as described above. In this embodiment, the notification module 28 notifies, during a period in which an inquiry is issued by the second inquiry module 36b, success or failure of job execution that is determined based on a result of the inquiry issued by the second inquiry module 36b to the OSS 10 as described above.

During a period in which the first inquiry module 36a and the second inquiry module 36b each issue an inquiry, the notification module 28 in this embodiment notifies both of success or failure of job execution that is determined based on a result of the inquiry issued by the first inquiry module 36a and success or failure of job execution that is determined based on a result of the inquiry issued by the second inquiry module 36b to the OSS 10.

In this embodiment, the following case is discussed as an example. After the destination to which an execution request to execute a job is output is switched to the second execution control module 32b, a job having the job ID of “0103” is confirmed by the first inquiry module 36a to have ended abnormally as shown in FIG. 3. The notification module 28 transmits an abnormal completion notification about this job to the OSS 10. The OSS 10 transmits a request to retry the job to the job management system 12. A piece of job data indicating the job is stored in the job data storage unit 22. The execution request output module 24 acquires this piece of job data.

In this case, in this embodiment, the execution request output module 24 outputs an execution request to execute a job corresponding to the acquired piece of job data to the second relay module 38b included in the second execution control module 32b.

In this embodiment, when execution of a job that has not been completed by the first job execution module 14a is determined to be a failure based on a result of an inquiry issued by the first inquiry module 36a to the first job execution module 14a after the destination to which an execution request to execute a job is output is switched to the second execution control module 32b, the execution request output module 24 thus outputs an execution request to execute the failed job to the second execution control module 32b.

The output of the execution request is, as described above, accompanied by generation of a piece of job status data associated with the job and storing of the generated piece of job status data in the job status data storage unit 34 by the second execution control module 32b.

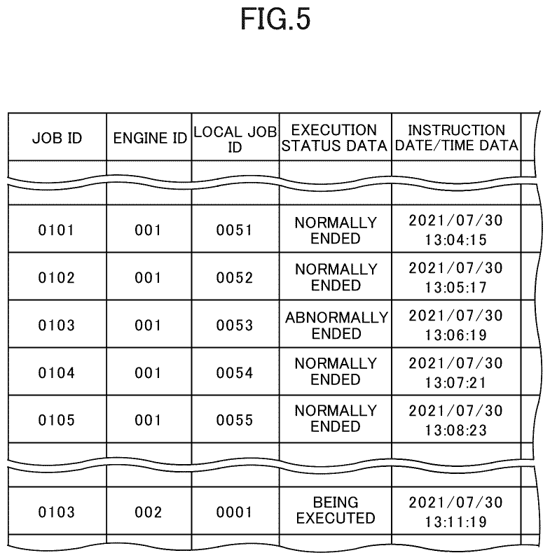

In FIG. 5, the piece of job status data newly stored in this manner is shown at the bottom. A value “0103”, which is the same as the job ID of the abnormally ended job, is set to the value of the job ID of this piece of job status data. A value “002” associated with the second job execution module 14b is set to the value of the engine ID of this piece of job status data.

In the example of FIG. 5, “0001”, which is identification information locally managed by the second job execution module 14b and assigned to a job instructed to be executed by the second job execution module 14b, is set as the value of the local job ID of this piece of job status data. In the example of FIG. 5, this value of the local job ID differs from the local job ID of a piece of job status data that is associated with the job executed by the first job execution module 14a.

In this embodiment, the case in which execution of a job that has not been completed by the first job execution module 14a is determined to be a failure is not limited to the case in which the job is confirmed to have ended abnormally as described above. For example, a case in which a job that has not been completed by the first job execution module 14a times out corresponds to the case in which execution of a job that has not been completed by the first job execution module 14a is determined to be a failure. Accordingly, in this embodiment, the execution request output module 24 outputs an execution request to execute a job to the second execution control module 32b also when a job that has not been completed by the first job execution module 14a times out.

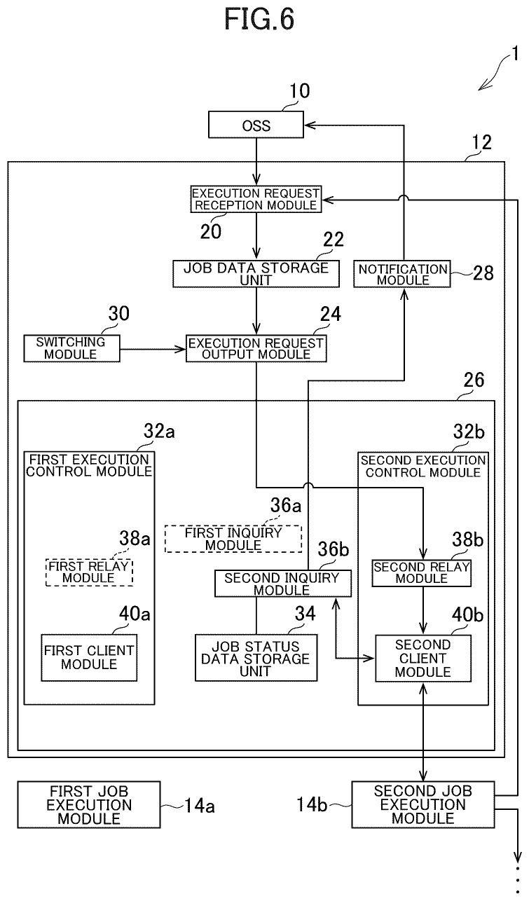

In this embodiment, the first inquiry module 36a ends issuing of an inquiry in response to, for example, completion of determination on success or failure of execution for every job for which execution has been instructed to the first job execution module 14a, based on a result of an inquiry to the first job execution module 14a. As illustrated in FIG. 6, the first inquiry module 36a may shut itself down in response to completion of determination on success or failure of execution for every job for which execution is instructed to the first job execution module 14a, based on a result of an inquiry to the first job execution module 14a.

The first inquiry module 36a may detect, for every piece of job status data having “001” as the value of the engine ID out of pieces of job status data stored in the job status data storage unit 34, that any one of conditions (1) the value of the execution status data is “normally ended,” (2) the value of the execution status data is “abnormally ended,” and (3) a corresponding job has timed out is satisfied. The first inquiry module 36a may use this detection as a trigger to end issuing of an inquiry to the first job execution module 14a. The first inquiry module 36a may then shut itself down.

Alternatively, the first inquiry module 36a may end issuing of an inquiry in response to, for example, confirmation that execution has ended for every job for which execution has been instructed to the first job execution module 14a, based on a result of an inquiry to the first job execution module 14a. For example, the first inquiry module 36a may detect, for every piece of job status data having “001” as the value of the engine ID out of pieces of job status data stored in the job status data storage unit 34, that any one of conditions (1) the value of the execution status data is “normally ended” and (2) the value of the execution status data is “abnormally ended” is satisfied. The first inquiry module 36a may use this detection as a trigger to end issuing of an inquiry to the first job execution module 14a. The first inquiry module 36a may then shut itself down.

The first inquiry module 36a may end issuing of an inquiry to the first job execution module 14a after a predetermined time elapses since activation of the second job execution module 14b. The first inquiry module 36a may then shut itself down.

The job data storage unit 22 may be implemented by, for example, Apache Kafka (trademark). The execution request output module 24 may be implemented as, for example, a Kafka consumer.

In this embodiment, running of the second job execution module 14b can be started regardless of presence of a job that has not been completed by the first job execution module 14a. After the second job execution module 14b starts running, the execution request output module 24 outputs an execution request to execute a job to the second execution control module 32b, without outputting any execution requests to the first execution control module 32a, and the second execution control module 32b instructs the second job execution module 14b to execute the job. The first job execution module 14a is consequently not instructed to execute a new job once the second job execution module 14b starts running.

Execution of a job that has not been completed by the first job execution module 14a is not forcefully ended and is continued even after the second job execution module 14b starts running. The status of the uncompleted job continues to be checked.

When execution of the job that has not been completed by the first job execution module 14a is subsequently determined to be a failure because the job is confirmed to have ended abnormally or has timed out, or for other reasons, an execution request to execute the job for a retry is output to the second job execution module 14b instead of the first job execution module 14a.

Thus, after the running of the second job execution module 14b is started, the first job execution module 14a does not execute again a job for which execution by the first job execution module 14a has failed, and the first job execution module 14a is freed of the execution of this job. In this manner, jobs for which execution has been instructed to the first job execution module 14a prior to the switching between the job execution modules 14 are smoothly freed from the first job execution module 14a.

The switching between the job execution modules 14 does not affect transmission of an execution request to execute a job from the OSS 10 to the job management system 12.

According to this embodiment, seamless switching between the job execution modules 14 is accomplished in the manner described above.

This embodiment may be designed so that an abnormal completion notification linked to the job ID of a job for which execution has been determined to be a failure is not output to the notification module 28 when a predetermined condition is satisfied.

For example, output of an abnormal completion notification linked to the job ID of a job to the notification module 28 may be avoided for a job for which execution has been determined to be a failure. When a job is determined to be a failure and the number of times execution of the job is determined to be a failure in succession is equal to or less than a predetermined number of times, for example, output of an abnormal completion notification linked to the job ID of the job to the notification module 28 may be avoided.

In this case, the execution request output module 24 may output an execution request to execute the job to one of the execution control modules 32 without an abnormal completion notification being output to the notification module 28.

In this case, the execution request output module 24 outputs the execution request to execute the job to the first execution control module 32a when the output of the execution request precedes the switching of the destination to which an execution request to execute a job is output to the second execution control module 32b. After the destination to which an execution request to execute a job is output is switched to the second execution control module 32b, the execution request output module 24 outputs the execution request to execute the job to the second execution control module 32b.

The following case is discussed as an example. After the destination to which an execution request to execute a job is output is switched to the second execution control module 32b, execution of a job that has not been completed by the first job execution module 14a is determined to be a failure based on a result of an inquiry issued by the first inquiry module 36a. In this case, the execution request output module 24 may output an execution request to execute the job to the second execution control module 32b, without the notification module 28 notifying the failure of the execution of the job to the OSS 10. For example, when the number of times the execution of the job is determined to be a failure in succession is equal to or less than a predetermined number of times, the execution request output module 24 may output an execution request to execute the job to the second execution control module 32b without an abnormal completion notification being output to the notification module 28.

In this way, when execution of a job by one of the job execution modules 14 that is used prior to the switching fails, the job can be executed (retried) by one of the job execution modules 14 that is used after the switching, without requiring the OSS 10 to transmit an execution request again.

In this embodiment, the job management system 12 may detect activation of the second job execution module 14b, which is one of the job execution modules 14 that is now in use. The job management system 12 may then activate the second execution control module 32b and the second inquiry module 36b in response to the detection of the activation of the second job execution module 14b. The job management system 12 may detect activation of the second client module 40b. The job management system 12 may then activate the second relay module 38b and the second inquiry module 36b in response to the detection of the activation of the second client module 40b.

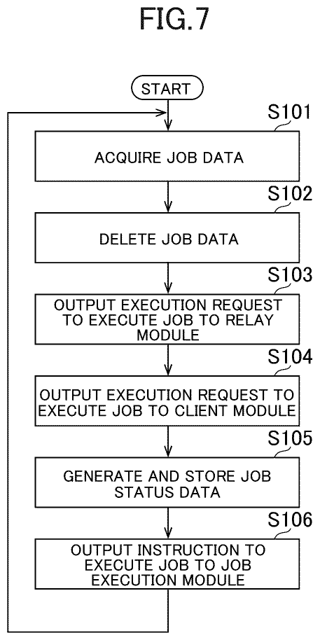

An example of a flow of a process that is executed in the job management system 12 according to this embodiment and that relates to execution of a job indicated by job data is described with reference to a flow chart illustrated in FIG. 7.

First, the execution request output module 24 acquires a piece of job data from the job data storage unit 22 (Step S101).

The execution request output module 24 deletes the piece of job data acquired in the process step of Step S101 from the job data storage unit 22 (Step S102).

The execution request output module 24 then outputs an execution request to execute a job corresponding to the piece of job data acquired in the process step of Step S101 to the one of the relay modules 38 of one of the execution control modules 32 that is set as an output destination (Step S103). In the process step of Step S103, the execution request to execute the job is output to, for example, the first relay module 38a when the output of the execution request precedes the switching between the job execution modules 14. After the switching between the job execution modules 14, the execution request to execute the job is output to the second relay module 38b.

The one of the relay modules 38 that has received the execution request to execute the job in the process step of Step S103 outputs the execution request to one of the client modules 40 (Step S104). In the process step of Step S104, the execution request to execute the job is output to, for example, the first client module 40a from the first relay module 38a when the output of the execution request precedes the switching between the job execution modules 14. After the switching between the job execution modules 14, the execution request to execute the job is output to the second client module 40b from the second relay module 38b.

The one of the relay modules 38 that has received the execution request to execute the job in the process step of Step S103 generates a piece of job status data associated with the job, and stores the piece of job status data in the job status data storage unit 34 (Step S105).

The one of the client modules 40 that has received the execution request to execute the job in the process step of Step S104 outputs an instruction to execute the job to the one of the job execution modules 14 (Step S106), and the process returns to Step S101. In the process step of Step S106, the first client module 40a, for example, outputs the instruction to execute the job to the first job execution module 14a when the output of the instruction precedes the switching between the job execution modules 14. After the switching between the job execution modules 14, the second client module 40b outputs the instruction to execute the job to the second job execution module 14b.

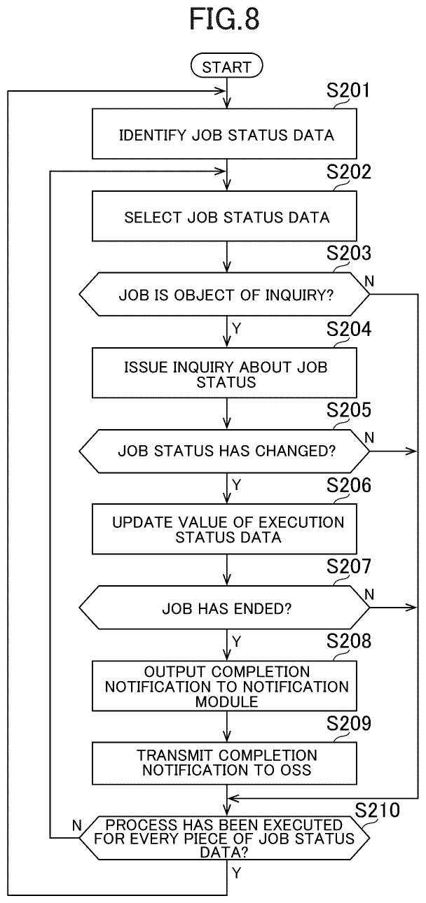

Next, an example of a flow of a process that is executed in the job management system 12 according to this embodiment and that relates to an inquiry about a status of a job being executed by one of the job execution modules 14 is described with reference to a flow chart illustrated in FIG. 8.

First, one of the inquiry modules 36 identifies, out of pieces of job status data stored in the job status data storage unit 34, pieces of job status data including an engine ID associated with one of the job execution modules 14 that is associated with the one of the inquiry modules 36 (Step S201).

Then, the one of the inquiry modules 36 selects, from the pieces of job status data identified in the process step of Step S201, one piece of job status data for which the process steps of Step S203 to Step S209 have not been executed (Step S202).

The one of the inquiry modules 36 then determines whether a job associated with the piece of job status data that has been selected in the process step of Step S202 is an object of inquiry, based on the selected piece of job status data (Step S203). The job may be determined to be an object of inquiry when, for example, the associated job is a job that has not been completed (for example, when the value of the execution status data included in the job status data associated with the job is “unexecuted” or “being executed”).

When the job is determined to be an object of inquiry (Step S203: Y), the one of the inquiry modules 36 issues an inquiry about the status of the job associated with the piece of job status data selected in the process step of Step S202 to the one of the job execution modules 14 that is associated with the one of the inquiry modules 36 (Step S204).

The one of the inquiry modules 36 then determines whether the status of the job has changed, based on a result of the inquiry in the process step of Step S204 (Step S205). In an example given here, whether a change from “unexecuted” to “being executed,” a change from “being executed” to “normally ended,” or a change from “being executed” to “abnormally ended” has occurred is determined. In the process step of Step S205, whether the job has timed out is determined as well.

When it is determined that there has been a change in the status of the job (Step S205: Y), the value of the execution status data in the piece of job status data associated with the job is updated to a value corresponding to the changed status (Step S206). For example, when it is confirmed that the job is now being executed, the value of the execution status data is changed to “being executed.” When it is confirmed that the job has ended normally, the value of the execution status data is changed to “normally ended.” When it is confirmed that the job has ended abnormally, the value of the execution status data is changed to “abnormally ended.” When it is determined in the process step of Step S205 that the job has timed out, the value of the execution status data may be changed to “abnormally ended.”

The one of the inquiry modules 36 then determines whether the job has ended (Step S207). For example, whether or not the value of the execution status data in the piece of job status data associated with the job has changed to “normally ended” or “abnormally ended” is determined.

When it is determined that the job has ended (Step S207: Y), the one of the inquiry modules 36 outputs a completion notification linked to the job ID of the job to the notification module 28 (Step S208). As described above, a normal completion notification is output to the notification module 28 when the job ends normally, and an abnormal completion notification is output to the notification module 28 when the job ends abnormally.

The notification module 28 transmits the completion notification input from the one of the inquiry modules 36 in the process step of Step S208 to the OSS 10 (Step S209).

The one of the inquiry modules 36 then confirms, for every piece of job status data identified in the process step of Step S201, whether the process steps of Step S203 to Step S209 have been executed (Step S210). The process step of Step S210 is executed also when the job is determined not to be an object of inquiry in the process step of Step S203 (Step S203: N). The process step of Step S210 is executed also when it is determined in the process step of Step S205 that the status of the job has not changed (Step S205: N). The process step of Step S210 is executed also when it is not determined in the process step of Step S207 that the job has ended (Step S207: N).

When not all pieces of job status data identified in the process step of Step S201 are finished with execution of the process steps of Step S203 to Step S209 (Step S210: N), the process returns to Step S202.

When all pieces of job status data identified in the process step of Step S201 are finished with execution of the process steps of Step S203 to Step 3209 (Step S210: Y), the process returns to Step S201.

In the process step of Step S207, whether execution of the job has ended abnormally may be determined. When it is determined that the execution of the job has ended abnormally, a process in which the execution request output module 24 outputs an execution request to execute the job for a retry to one of the relay modules 38 may be executed instead of the process step of Step S208 described above.

For example, each of the inquiry modules 36 may hold data indicating the number of times the execution of jobs having the same job ID has failed in succession. When the number of times the execution of the job has been determined to be a failure in succession is equal to or less than a predetermined number of times, the process in which the execution request output module 24 outputs an execution request to execute the job for a retry to one of the relay modules 38 may be executed instead of the process step of Step S208 described above.

The process steps of Step S201 to Step S210 are executed in the same manner in the first inquiry module 36a and the second inquiry module 36b.

In this embodiment, when, for example, it is confirmed in the process step of Step S210 that execution of the process steps of Step S203 to Step S209 is finished for every piece of job status data identified in the process step of Step S201 after the destination to which an execution request to execute a job is output is switched to the second execution control module 32b, the first inquiry module 36a subsequently confirms whether every job associated with the pieces of job status data identified in the process step of Step S201 has ended.

When it is confirmed that every job associated with the pieces of job status data identified in the process step of Step S201 has ended, the first inquiry module 36a shuts itself down. Otherwise, the process returns to Step S201.

It should be noted that the present invention is not limited to the above-mentioned embodiment.

Further, the specific numerical values and character strings described above and the specific numerical values and character strings in the drawings are merely exemplary, and the present invention is not limited to those numerical values and character strings.

1. A job management system, comprising:
at least one processor; and
at least one memory device storing instructions which, when execute by the at least one processor, cause the at least one processor to perform operations comprising:
executing a first execution control module to instruct, in response to reception of an execution request to execute a job, a first job execution module to execute the job;
executing a second execution control module to instruct, in response to reception of an execution request to execute a job, a second job execution module to execute the job;
outputting one execution request to execute a job at a time to the first execution control module;
switching, when a job uncompleted by the first job execution module exists, a destination to which an execution request to execute a job is output, from the first execution control module to the second execution control module; and
issuing, to the first job execution module, an inquiry about a status of a job for which execution has been instructed to the first job execution module,
wherein, when execution of a job uncompleted by the first job execution module is determined to be a failure based on a result of the inquiry after the destination to which an execution request to execute a job is output is switched to the second execution control module, an execution request to execute the job is output to the second execution control module.

2. The job management system according to claim 1, wherein the operations further comprise ending the issuing of an inquiry in response to completion of determination, based on a result of the inquiry, on success or failure of execution for every job for which execution has been instructed to the first job execution module.

3. The job management system according to claim 1, wherein the operations further comprise ending the issuing of an inquiry in response to confirmation, based on a result of the inquiry, that execution has ended for every job for which execution has been instructed to the first job execution module.

4. The job management system according to claim 1, wherein the operations further comprise:
receiving an execution request to execute a job from an operation support system;
storing job data indicating the job, and
acquiring one piece of the stored job data at a time,
wherein outputting the execution request comprises outputting, in response to acquisition of a piece of the job data, an execution request to execute a job indicated by the piece of the job data to the first execution control module, before the destination to which an execution request to execute a job is output is switched to the second execution control module, and
wherein outputting the execution request comprises outputting, in response to acquisition of a piece of the job data, an execution request to execute a job indicated by the piece of the job data to the second execution control module, after the destination to which an execution request to execute a job is output is switched to the second execution control module.

5. The job management system according to claim 4, wherein the operations further comprise notifying, to the operation support system, success, or failure of execution of a job that is determined based on a result of the inquiry.

6. The job management system according to claim 5, wherein the operation further comprise issuing, to the second job execution module, an inquiry about a status of a job for which execution has been instructed to the second job execution module,
wherein notifying comprises notifying, to the operation support system, during a period in which an inquiry is issued to the first job execution module and an inquiry to the second job execution module, success or failure of execution of a job that is determined based on a result of an inquiry issued to the first job execution module and success or failure of execution of a job that is determined based on a result of an inquiry issued to the second job execution module.

7. The job management system according to claim 5, wherein, when execution of a job uncompleted by the first job execution module is determined to be a failure based on a result of the inquiry after the destination to which an execution request to execute a job is output is switched to the second execution control module, outputting the execution request comprises outputting an execution request to execute the job to the second execution control module, without notifying the failure of the execution of the job to the operation support system.

8. A control method for a job management system,
the job management system including:
at least one processor; and
at least one memory device storing instructions which, when executed by the at least one processor, cause the at least one processor to perform operations comprising:
executing a first execution control module to instruct, in response to reception of an execution request to execute a job, a first job execution module to execute the job; and
executing a second execution control module to instruct, in response to reception of an execution request to execute a job, a second job execution module to execute the job,
the control method comprising:
outputting one execution request to execute a job at a time to the first execution control module;
switching, when a job uncompleted by the first job execution module exists, a destination to which an execution request to execute a job is output, from the first execution control module to the second execution control module;
issuing, to the first job execution module, an inquiry about a status of a job for which execution has been instructed to the first job execution module; and
outputting, when execution of a job uncompleted by the first job execution module is determined to be a failure based on a result of the inquiry after the destination to which an execution request to execute a job is output is switched to the second execution control module, an execution request to execute the job to the second execution control module.
